(19) United States
(12) Patent Application Publication
(10) Pub. No.: US 2026/0060164 A1
(43) Pub. Date: Mar. 5, 2026

(54) CLOSING WHEEL

(71) Applicant: SCHAFFERT MANUFACTURING COMPANY, INC., Indianola, NE (US)

(72) Inventor: Paul E. SCHAFFERT, Indianola, NE (US)

(21) Appl. No.: 19/315,201

(22) Filed: Aug. 29, 2025

Related U.S. Application Data
(63) Continuation of application No. 29/960,306, filed on Aug. 29, 2024.
(60) Provisional application No. 63/688,715, filed on Aug. 29, 2024.
(60) Provisional application No. 63/845,665, filed on Jul. 17, 2025.

(51) Int. Cl. A01C 5/06

(52) U.S. Cl. CPC A01C 5/068

(57) ABSTRACT

A closing wheel for a planter is disclosed. The closing wheel includes a hub, a rim coupled to the hub and including a periphery, a first plurality of projections extending radially beyond the periphery, and a second plurality of projections extending radially beyond the periphery. The first plurality of projections and the second plurality of projections extend at least partially axially outward relative to the hub, and the first plurality of projections and the second plurality of projections extend at least partially in different directions.

### CROSS-REFERENCE TO RELATED APPLICATIONS

This application claims the benefit of priority pursuant to 35 U.S.C. § 119 (e) of U.S. Provisional Patent Application No. 63/688,715, filed Aug. 29, 2024, title “CLOSING WHEEL” and U.S. Provisional Patent Application No. 63/845,665, filed Jul. 17, 2025, titled “CLOSING WHEEL,” and U.S. Design application Ser. No. 29/960,306, filed Aug. 29, 2024, entitled “FURROW CLOSING WHEEL,” each of which are incorporated herein by reference in their entirety and for all purposes.

### FIELD

The described embodiments relate generally to agricultural components. More particularly, the present embodiments relate to agricultural wheels for planters.

### BACKGROUND

Multi-row planters are used for agricultural seed planting. A planter may include multiple row units configured for opening a seed furrow, depositing seeds within the furrow, and closing the seed furrow around the seeds. Further, a closing wheel may often be used for closing the seed furrow by moving the soil in the seeded furrows after the seed has been planted. However, opening the seed furrow using wheels and discs of current planters and trailing arm assemblies often hardens sidewalls and/or compacts the soil, such as in the sidewall of the furrow, during the process, thus forming furrow sidewalls that may adversely impact the furrow closing, and may result in poor seed to soil contact, and thus the development and growth of the seeded crop.

Conventional press or closing wheels may include a hub having a fixed diameter from a central rotational axis of the closing wheel. Conventional closing wheels often include a tire or other feature defining the perimeter. The conventional closing wheels attempt to close the seed furrow by applying a force to push, smear, or collapse dirt into the seed furrow. However, the conventional pushing and smearing is often insufficient to break down the sidewalls of the opened seed furrow or properly cover the seed with soil. Further, conventional closing wheels may bounce or lift above a field surface while traversing a field, for example due to the elastic nature of the tires, debris in the field, or simply due to uneven terrain. As a result, the closing wheels may fail to contact portions of the soil and close a furrow or place soil on the deposited seed. Accordingly, an improved closing wheel improving distribution of soil over a deposited seed is needed.

### SUMMARY

Examples of the present invention are directed to an agricultural wheel.

In one example, a closing wheel is disclosed. The closing wheel is coupled to a trailing arm assembly of a planter. The closing wheel includes a hub, a rim coupled to the hub and including a periphery, a first plurality of projections extending radially beyond the periphery, and a second plurality of projections extending radially beyond the periphery. The first plurality of projections and the second plurality of projections extend at least partially axially outward relative to the hub, and the first plurality of projections and the second plurality of projections extend at least partially in different directions.

In some examples, the hub is configured to rotate about an axis of rotation.

In some examples, the first plurality of projections are axially spaced from the second plurality of projections.

In some examples, the first plurality of projections and the second plurality of projections extend at least in one direction that is at a non-orthogonal angle relative to a major plane of the hub, the major plane of the hub being orthogonal to the axis of rotation.

In some examples, at least one of the first plurality of projections or the second plurality of projections are spaced annularly about the rim.

In some examples, the first plurality of projections and the second plurality of projections are symmetrical about a major plane defined by the rim.

In some examples, the rim includes a collar defining the first plurality of projections or the second plurality of projections.

In some examples, the collar is separate from and coupled rim at or adjacent the to the periphery.

In some examples, the collar is a first collar coupled to a first side of the rim and defining the first plurality of projection, and the closing wheel further includes a second collar defining the second plurality of projections, the second collar coupled to a second side of the rim opposite the first side.

In some examples, an axial thickness of the rim defines at least a portion of an axial spacing between the first plurality of projections and the second plurality of projections. In some examples, a seed gap volume is defined in part by the rim, the first plurality of projections and the second plurality of projections.

In some examples, the at least one collar is coupled to the rim by at least one of a fastener or a weld.

In some examples, the first plurality of projections and the second plurality of projections are integrally formed with the rim. Such as a single piece.

In some examples, a first projection of the first plurality of projections terminates at a first tip, a second projection of the second plurality of projections terminates at a second tip.

In some examples, an axial width of the closing wheel is defined by an axial distance between the first tip and the second tip.

In some examples, the axis of rotation is oriented substantially parallel to a surface of a field.

In one example, an agricultural wheel configured to rotate about an axis of rotation is disclosed. The agricultural wheel includes a rim and defining a periphery, first projections extending axially outward from the periphery in a first direction, and second projections extending axially outward from the periphery in a second direction different from the first direction. The first projections are circumferentially spaced about the rim, and the second projections are circumferentially spaced about the rim.

In some examples, the first projections and the second projections extend radially from the rim. For example, beyond the periphery of the rim.

In some examples, the agricultural wheel further includes a first collar defining the first projections and coupled to the rim, a second collar defining the second projection and coupled to the rim, and the first collar and the second collar are separately formed from and connected to the rim.

In some examples, the rim rotates in a first direction about the axis of rotation to define an ascending region moving upward and a descending region moving downward relative to the axis of rotation and a field surface.

In some examples, the first projections or the second projections extend at least partially downward from the periphery at the ascending region towards the field surface.

In some examples, the first projections or the second projections extend at least partially upward from the periphery at the descending region in a direction away from the field surface.

In some examples, the rim defines a major plane orthogonal to the axis of rotation, and the first projections and the second projections rotate substantially in plane parallel to the major plane.

In one example, a wheel for an agricultural assembly configured to rotate about an axis of rotation is disclosed. The wheel includes a rim including a periphery, first projections extending radially outward from a first side of the rim, and second projections extending radially outward from a second side of the rim opposite the first side.

In some examples, the first projections and the second projections are spaced apart along the axis of rotation, and a seed gap volume is defined between the projections to permit the passage of a seed between the first projections and the second projections when the first projections and the second projections are engaged with a furrow during use

In some examples, the wheel includes a hub configured to rotate about an axis of rotation and the rim is coupled to the hub.

In some examples, the first projections terminate at a first edge, the second projections terminate at a second edge, and the first edge is axially spaced apart from the second edge.

In another example, the first projections terminate at a first edge, the second projections terminate at a second edge, and the first edge is axially spaced apart from the second edge.

In another example, the first projections and the second projections define an axial width and a radial width of the wheel.

In another example, the wheel further includes a first plurality of protrusions extending from the first side and positioned radially inward from the periphery, and a second plurality of protrusions extending from the second side and positioned radially inward from the periphery.

In another example, the first plurality of protrusions extend axially from the periphery in a first direction away from the central rim, and the second plurality of protrusions extend axially from the periphery in a second direction away from the central rim.

In another example, the wheel further includes a scraper assembly including a scraper feature positioned at or adjacent the first projections or the second projections.

In another example, the scraper feature is positioned radially outward from the first projections or the second projections.

In another example, the scraper feature is positioned between the first projections and the second projections.

In another example, an angular position of the scraper feature relative to the closing wheel is adjustable.

In another example, the wheel includes a scraper assembly extending from adjacent the hub radially outward to a position at or adjacent a perimeter of the wheel.

In another example, the perimeter is defined by one of the rim, the first projections, or the second projections.

In another example, the scraper assembly includes a linkage extending from the hub or at or adjacent the axis of rotation to the position and including a mounting feature spaced from the periphery, and a scraper for removing debris from the wheel is coupled to the mounting feature at an adjustable connection.

In another example, the scraper is movable by the adjustable connection to a position radially towards or away from the periphery, the first projections, or the second projections.

In another example, the scraper is movable by the adjustable connection in a direction along the axis of rotation and along a width dimension of the wheel.

A number of feature refinements and additional features are applicable in the first aspect and contemplated in light of the present disclosure. These feature refinements and additional features may be used individually or in any combination. As such, each of the following features that will be discussed may be, but are not required to be, used with any other feature combination of the first aspect.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a side view of an agricultural tractor and an agricultural planter;

FIG. 2 depicts a top-rear perspective view of the agricultural tractor and agricultural planter of FIG. 1, with a closing wheel;

FIG. 3 depicts a top-rear perspective view of a tail section of the agricultural planter and the closing wheel of FIG. 2;

FIG. 4A depicts a rear elevation view of a pair of example closing wheels and a seed in an open seed furrow;

FIG. 4B depicts a rear elevation view of the closing wheels of FIG. 4A and a seed in a closed seed furrow;

FIG. 5A depicts a perspective view of a first example closing wheel;

FIG. 5B depicts a perspective view of a second example closing wheel;

FIG. 6 depicts an exploded view of the closing wheel of FIG. 5A;

FIG. 7A depicts a side elevation view of the closing wheel of FIG. 5A;

FIG. 7B depicts an enlarged view of a portion of the closing wheel of FIG. 7A as indicated by line 7B-7B in FIG. 7A;

FIG. 8A depicts a front elevation view of a portion of the closing wheel of FIG. 5A;

FIG. 8B depicts an enlarged view of a portion of the closing wheel of FIG. 8A as indicated by line 8B-8B in FIG. 8A;

FIG. 9A depicts a perspective view of another example configuration of a closing wheel; and

FIG. 9B depicts a cross sectional view of the closing wheel of FIG. 9A taken along line 9B-9B;

FIG. 10 depicts a perspective view another example configuration of a closing wheel;

FIG. 11 depicts an exploded view of an example closing wheel;

FIG. 12A depicts a perspective view of the example closing wheel of FIG. 5A and an example scraper assembly;

FIG. 12B depicts a perspective view of the example closing wheel of FIG. 5A and another example scraper assembly;

FIG. 12C depicts a perspective view of the example closing wheel of FIG. 5A and another example scraper assembly;

FIG. 12D depicts an elevation view of the example closing wheel and an example scraper assembly of FIG. 12B; and

FIG. 13 depicts a perspective view of the example closing wheel of FIG. 5A and an example scraper assembly.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to closing wheels and associated systems and methods of use thereof. Closing wheels are often a part of a trailing arm assembly, which may be coupled to a hitch of an agricultural planter (e.g. tractor or combine) and pulled over soil. The trailing arm assembly may include features or implements to open a seed furrow and deposit one or more seeds. Broadly, a closing wheel may be substantially any type of wheel or soil distributing device for closing seeded furrows by distributing soil over or into the open furrow. However, conventional closing wheels may fail to consistently or properly distribute soil to cover the seeds, or distribute the soil in a way to promote the growth of the planted seed. For example, hardened sidewalls may be formed that limit root growth, movement of moisture, or even compaction of the soil.

The closing wheels described in the present disclosure achieve sufficient and consistent seed furrow closing across uneven terrain, field debris, and various soil conditions. In order to achieve these advantages, closing wheels described herein may include a hub and rim configured to rotate about an axis of rotation, with two or more series of projections extending outward relative to a periphery of the closing wheel. The projections may be teeth, tines, or other projections for engaging with and breaking up soil. In some examples, the projections may be continuous or segmented (e.g. discretely defined or discontinuous). In such an example, the projections may be annularly spaced about the rim. The projections may be integrally formed with the rim or defined by a separate feature connected to the rim. For example, one or more collars including the projections may be coupled to the rim, such as along a side or along an outer perimeter.

The projections may extend radially beyond the periphery of the closing wheel. For example, the projects may extend radially outward, or away from the axis of rotation. The series of projections may be axially spaced. For example, either series of projections may extend outward axially (e.g. along the axis of rotation) such that a tip of a first series is spaced from a tip of a second series. The axial and radial spacing may define a gap or space between the projections. In some examples, the projections may be angled about the axis of rotation (e.g. circumferentially angled). For example, the projections may extend forward with a rotational direction or rearward against the rotational direction.

During operation, the closing wheel may distribute soil into the open furrow, or break down sidewalls of the open furrow, to close the furrow and cover the seed. For example, the closing wheel may rotate and move along the open seed furrow. The projections may engage the field surface at the sidewalls of the open furrow or adjacent the open furrow. As the closing wheel rotates, the projections break up the field surface including soil or debris, such as plant matter.

The radial and axial spacing of the projections of the closing wheel may position the tips of the projections away from the seed. For example, the radially and axially spaced projections may engage soil surrounding the seed, while avoiding disturbing or displacing the seed from the furrow. The axial extension of the projections may also direct close soil towards or over the seed.

The axial spacing and radial extension of the projections may also enable orienting the closing wheel with the axis of rotation substantially parallel to the field surface. As a result, the closing wheel may be oriented such that downward forces (e.g. weight or pressure from the components) may be oriented mostly vertical, providing more force to break up hardened soil or debris and resist bouncing. Further, the closing wheels may be spaced narrowly or widely apart without contacting adjacent trailing arm assemblies.

In some examples, the circumferential angle of the projections may assist in breaking down or compacting the dirt. For example, the projections may extend at angle opposing direction of rotation, such that the projections lift vertically from a closed seed furrow to prevent displacement of soil while exiting a closed furrow. In some examples, the projections may be oriented with the direction of rotation to more aggressively break-up of the field surface.

Distributing soil and breaking down sidewalls of the furrow promote seed germination by compacting soil and minimizing air pockets. For example, breaking up the soil as much or consistently as possible reduces air pockets in the soil while also aerating the soil. This can improve the capillary action of the moisture in the soil, helping water reach the growing plant or promoting the development of symbiotic, or otherwise beneficial, organisms such as fungi or bacterium, as well as reducing wind erosion of the soil over the seed. Further, breaking down the seed furrow sidewalls and covering the seed with consistent quantities of soil may promote root development and robustness of the plant during periods of increased wind, precipitation, or heat.

In some examples, the closing wheel includes one or more spacers positioned between one or more of the rim and a collar, or additional features. The spacers may be rigid or semi-rigid components to increase an axial width of the wheel, or an axial spacing of the projections. As a result, the spacers may enable the closure of a larger, or varying, seed furrows. The spacers may also assist in interlacing the soil adjacent the furrow with the closed seed furrow soil to promote root development and distribution of moisture.

In some examples, the closing wheel includes one or more tread wheels. The tread wheels may be defined by a plurality of annularly positioned protrusions. The protrusions may be axially extending, at least in part, tines, blades, rods, or the like. The protrusions may be positioned radially inward (toward a center hub) from the projections and positioned on or within the top of the soil during rotation and use of the closing wheel. The tread wheel may assist in interlacing the soil adjacent the furrow with the closed furrow to promote root development and distribution of moisture. The tread wheel may assist in compacting the closed furrow by tamping down on the top of the soil to remove air pockets.

In some examples, the closing wheel assembly includes a scraper assembly. The scraper assembly may include a scraper or debris removing feature. The scraper feature may be positioned at or adjacent the periphery or the projections. During rotation and use, the scraper feature may contact one or more projection, and in some examples resiliently deflect based on the contact with the one or more projection, and by that contact remove debris from the closing wheel to provide consistent closing of an open seed furrow.

Reference will now be made to the accompanying drawings, which assist in illustrating various features of the present disclosure. The following description is presented for purposes of illustration and description. Furthermore, the description is not intended to limit the inventive aspects to the forms disclosed herein. Consequently, variations and modifications commensurate with the following teachings, and skill and knowledge of the relevant art, are within the scope of the present inventive aspects.

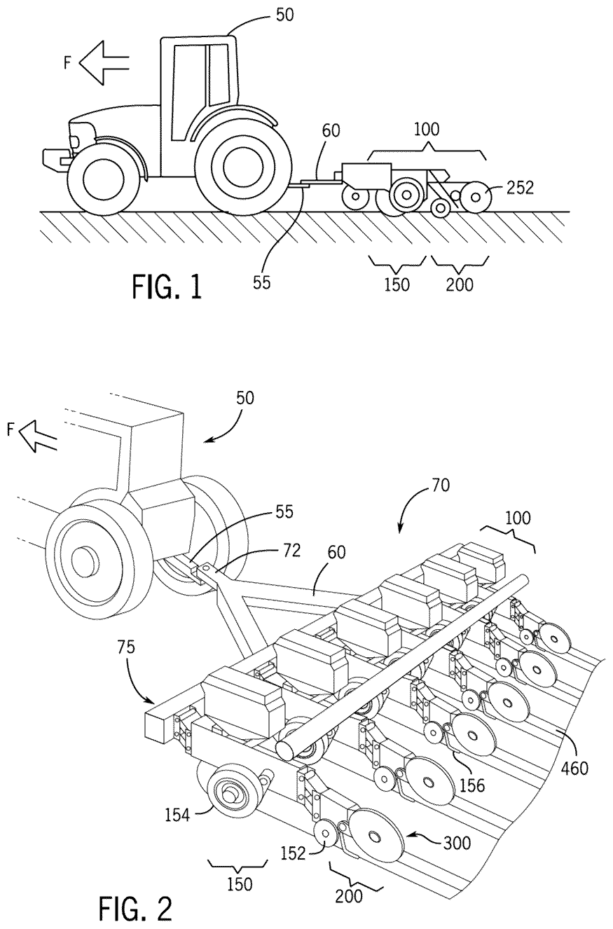

Turning to the Drawings, the closing wheel 300 of the present disclosure may be used with a variety of different planters and trailing arm assemblies. For purposes of illustration, FIGS. 1 and 2 show the planter 70 as including a tongue or hitch 60 for hitching the planter 70 to a hitch 55 of a tractor 50. The tractor 50 tows the planter 70 in the direction of arrow F and provides power to the planter 70 (e.g., via a power take off (“PTO”)) for powering the operations of the planter 70. As illustrated in FIG. 2, the planter 70 may include a frame 75 from which the hitch 60 extends and the various planter components are supported, such as a plurality of spaced trailing arm assemblies 100. The trailing arm assemblies 100 may function as row units for planting seeds or distributing liquid fertilizer.

The closing wheel 300 of the present disclosure may be used with the one or more trailing arm assemblies or row units 100, as shown in FIGS. 1-3. As described and shown herein, one or more closing wheels, such as the closing wheel 300 of the present disclosure may be connected to a portion, such as an end, of some or all of the trailing arm assemblies 100. While many configurations are possible, each trailing arm assembly 100 may include a fertilizer furrow opener assembly 150. The row units, as may be shown in FIG. 2, may include a furrow opener 152, a gage wheel 154, and a seed hopper 156. The fertilizer furrow opener assembly 150 may open the soil, such as with the furrow opener 152, and optionally supply fertilizer and/or seed to an open furrow 450. The gage wheel 154 may be determine or control a depth at which the planter 70 deposits the seed, or a depth of the furrow opener 152 or the closing wheel 300.

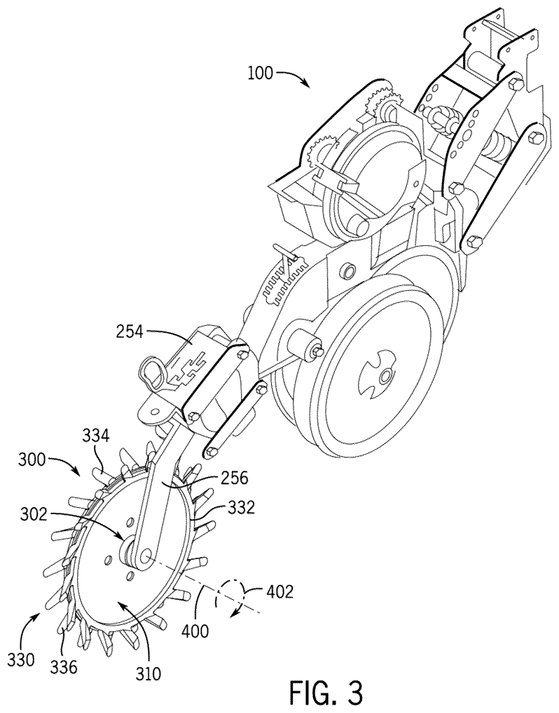

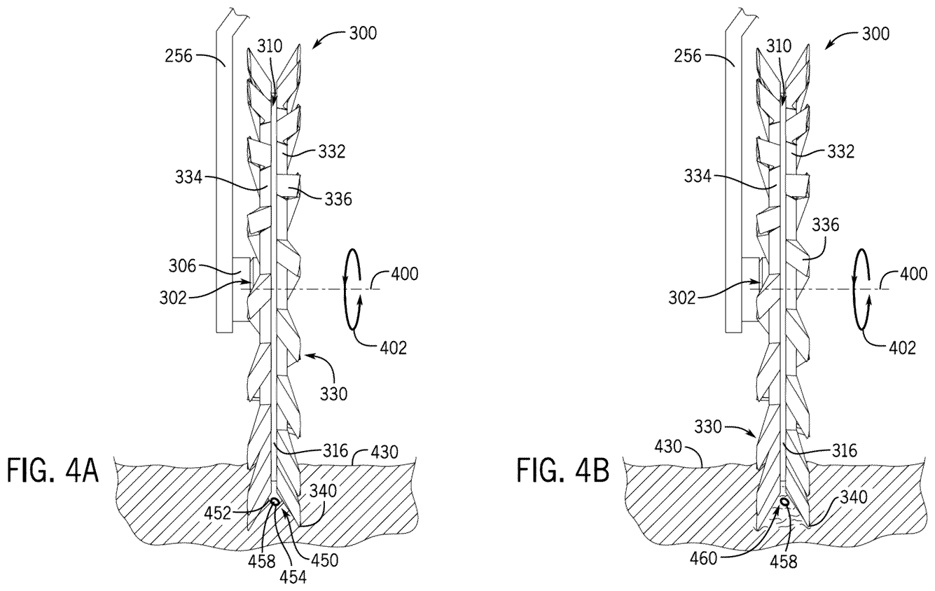

Each trailing arm assembly 100 may also include a trailing furrow closer assembly 200. The furrow closer assembly 200 may include the closing wheel 300, which may be optionally followed by a press wheel 252, shown in FIG. 1, or other subassemblies. The closing wheel 300 may be connected to the trailing arm assembly 100 by a mounting fork 254 including an extension 256 connected to the closing wheel 300, as exemplified in FIG. 3. The closing wheel 300 may break down a seed furrow 450, or cover a seed deposited in the open seed furrow 450 with soil, as may be shown in greater detail in FIGS. 4A-4B. In some examples, the trailing arm furrow closer assembly 200 includes the press wheel 252 to tamp, even, or firm soil of a closed seed furrow 460.

Any of the features, components, and/or parts, including the arrangements and configurations thereof shown in FIGS. 1-3 can be included, either alone or in any combination, in any of the other examples of devices, features, components, and parts shown in the other Figures. Likewise, any of the features, components, and/or parts, including the arrangements and configurations thereof shown in the other Figures can be included, either alone or in any combination, in the example of the devices, features, components, and parts shown in FIGS. 1-3.

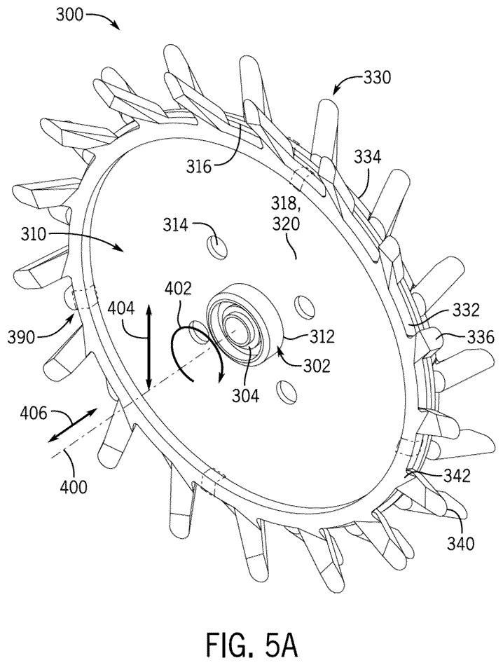

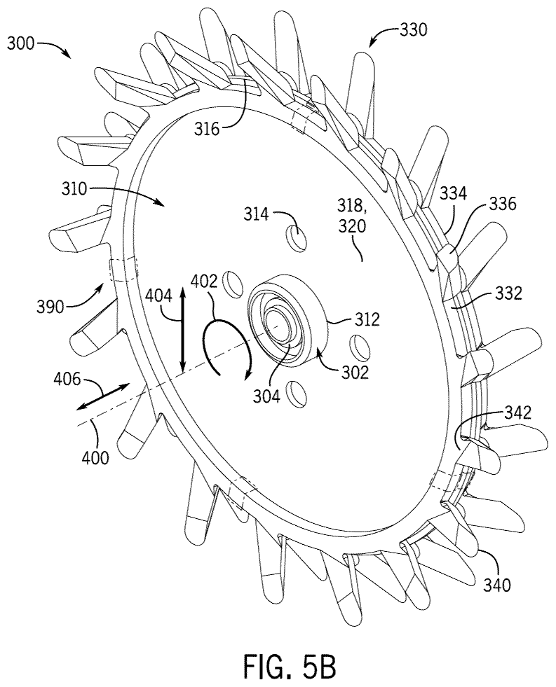

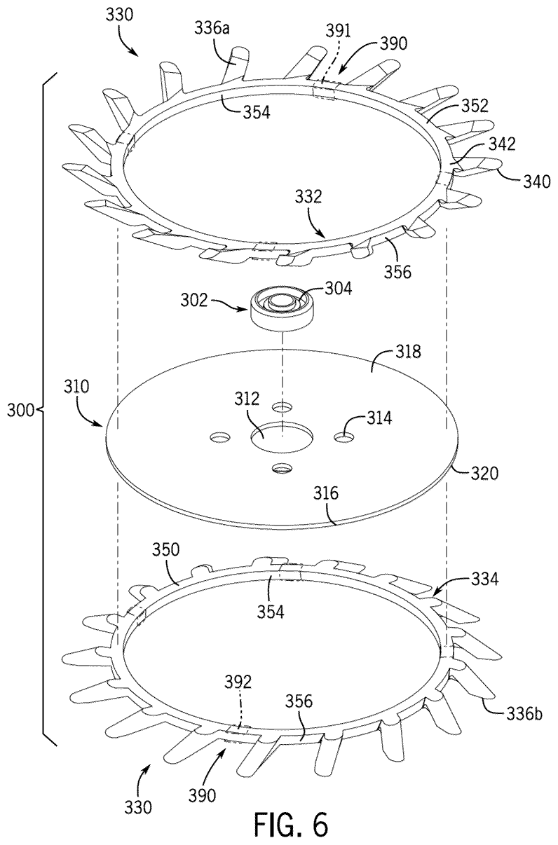

Turning to FIGS. 5A-8B, with specific reference to FIGS. 5A-6, an example of the closing wheel 300 is depicted. The closing wheel 300 may be generally circular when viewed along an axis of rotation 400 and rotate about the axis of rotation 400. The closing wheel 300 may include a central hub 302 and a rim 310. The closing wheel 300 may optionally include a collar 330. For reference purposes, the wheel 300 may, in one configuration, rotate about the axis of rotation 400 in a rotational direction 402. A radial direction 404 may be defined generally orthogonal to the axis of rotation 400. An axial direction 406 may be defined extending parallel or coincident with the axis of rotation 400.

The hub 302 may be a centrally located or rotatable feature of the closing wheel 300. For example, the hub 302 may be positioned about the axis of rotation 400. The hub 302 may include a central component 304 such as a bushing, bearing, or the like. The central component 304 may enable rotation of the hub 302, or connected features, about the axis of rotation 400. In some examples, the central component 304 may connect with a separately rotatably feature, such as an axle or bearing of the trailing arm assembly 100.

The rim 310 may define a main body of the wheel 300. In some examples, the rim 310 may be generally circular or elliptical about the axis of rotation 400. The rim 310 may be a unitary structure or include one or more components connected together to define the rim 310. The rim 310 may be a plate, disc, or formed by the interconnection of one or more spokes or other radially extending features together defining the rim 310. A continuous rim 310, such as a plate or disc, may shed mud or plant debris during use.

The rim 310 may define a central aperture 312 extending axially through the rim 310. The central aperture 312 may be defined about the axis of rotation 400. The rim 310 may optionally include one or more secondary apertures 314. The secondary apertures 314 may be spaced from the central apertures 312. In some examples, a plurality of secondary apertures 314 may be arranged about the axis of rotation 400, such as annularly.

The rim 310 may have a periphery 316. The periphery 316 may be defined as a perimeter or outer edge of the rim 310, or a portion of the rim 310 adjacent the perimeter. The rim 310 may include axial sides or faces 318, 320. The axial sides 318, 320 may extend, at least in part, radially 404 or transverse relative to the axis of rotation 400. For example, the axial sides 318, 320 may define the left or right sides of the rim 310. The opposing sides 318, 320 may extend along or define a major plane extending in the radial direction 402, or orthogonally to the axis of rotation 400. The opposing sides 318, 320 may be flat or featureless, curved or domed, or the like. For example, a flat side 318, 320 may have a reduced width or volume, or a domed or curved side 318, 320 may shed debris or plant matter.

The closing wheel 300 may optionally include a collar 330. The collar 330 may be an annular feature radially spaced from the axis of rotation 400. In some examples, the collar 330 may be the radially outermost feature, or define the radially outermost features, of the wheel 300. The collar 330 extend about the axis of rotation 400. In some examples, the collar 330 is an annular feature such as a ring or flange. The collar 330 may be an at least partially axially extending (e.g. extending at least partially in the axial direction 406) portion or feature of the closing wheel 300. The collar 330 may include a first lateral side 350 and an opposite second lateral side 352. For example, the first lateral side 350 or opposite lateral side 352 may be oriented transverse to the axis of rotation 400. The collar 330 may include a radially interior side 354 and a radially exterior side 356. The collar 330 may be continuous or discontinuous (e.g. segmented or varying in width or thickness).

In some examples, the collar 330 may be integrally formed with the rim 310 or connected to the rim 310. The collar 330 may be a feature extending along or adjacent a portion or edge of the periphery 316. For example, the collar 330 may be positioned radially outward of the periphery 316. In such an example, the interior side 354 of the collar 330 may be defined or positioned at the periphery 316 of the rim 310. In some examples, the collar 330 may extend at least partially along a side 318, 320 of the rim 310. For example, the collar 330 may be positioned with the exterior side 356 radially inward of or aligned with the periphery 316. The collar 330 or rim 310 may define transition features at or adjacent contacting portions of the rim 310. For example, the interior side 354 or exterior side 356 of the collar 330 may be defined with a slope or curve to an adjacent surface of the rim 310. The slopes or curves may assist in clearing debris, such as plant material or mud, from the wheel 300 during use.

In examples where the collar 330 is formed with the rim 310, the collar 330 may be a flange, lip, band, or raised edge. In such an example, the rim 310 and collar 330 may be formed by casting or molding the components. The collar 330 may extend along, be spaced from, or define a portion of the periphery 316. In one example, the collar 330 extends about the rim 310 exterior to and positioned at the periphery. For example, the collar 330 may define a perimeter of the rim 310 or the wheel 300.

In examples where the collar 330 is separate from and connected to the rim 310, the collar 330 may be a ring, band, cap, or plate connected to the rim 310. The collar 330 may be connected to the periphery 316 of the rim 310. For example, the collar 330 may be positioned radially 404 outward from the periphery 316. In some examples, the collar 330 may be positioned to extend along or adjacent, the periphery 316 of the rim 310. For example, the collar 330 may be connected to a side 318, 320 of the rim 310. The collar 330 may be connected to the rim 310 by one or more fasteners, such as welds, bolts, or the like.

In some examples, the closing wheel 300 may include two or more collars 330. For example, the closing wheel 300 may include a first collar 332 and a second collar 334. In some examples, the first collar 332 or second collar 334 may be separately connected or spaced apart. For example, the first collar 332 and the second collar 334 may be axially 406 spaced. The first collar 332 may be connected in part to the first axial side 318 of the rim 310. The second collar 334 may be connected in part to the second axial side 320 of the rim 310. In such an example, the rim 310 may define an axial spacing of the first 332 and second collar 334. The first or second collar 332, 334 may be either the right or left collar. In some examples, the first collar 332 or second collar 344 may be connected together or in contact when connected to the rim 310, such as at or adjacent the periphery 316.

Each or either of the first collar 332 or the second collar 334 may be spaced radially 404 inward or outward (e.g. connected at a perimeter or outer edge) from the periphery 316. When the first or second collar 332, 334 are spaced radially 404 inward, the first or interior lateral sides 350 of the collars 332, 334 may be in contact with the axial side 318, 320 of the rim 310.

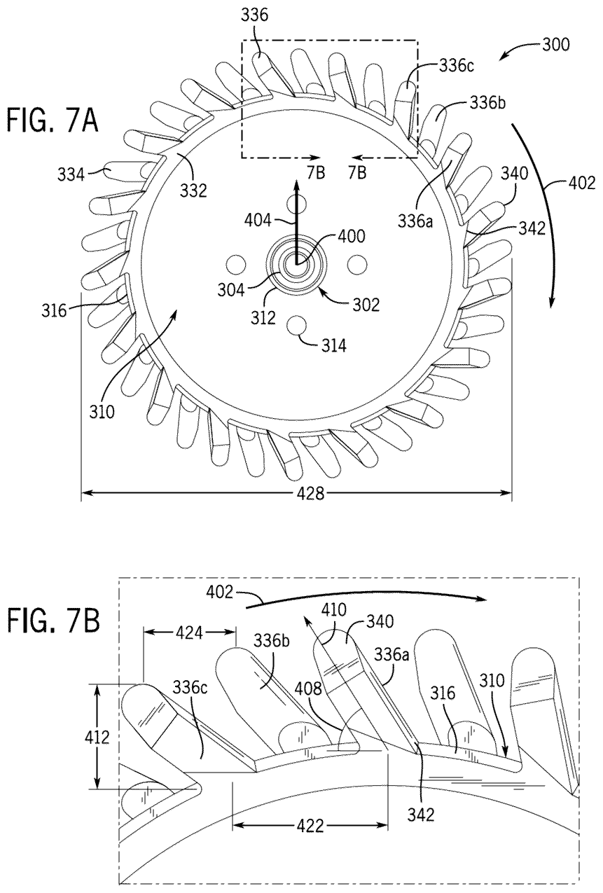

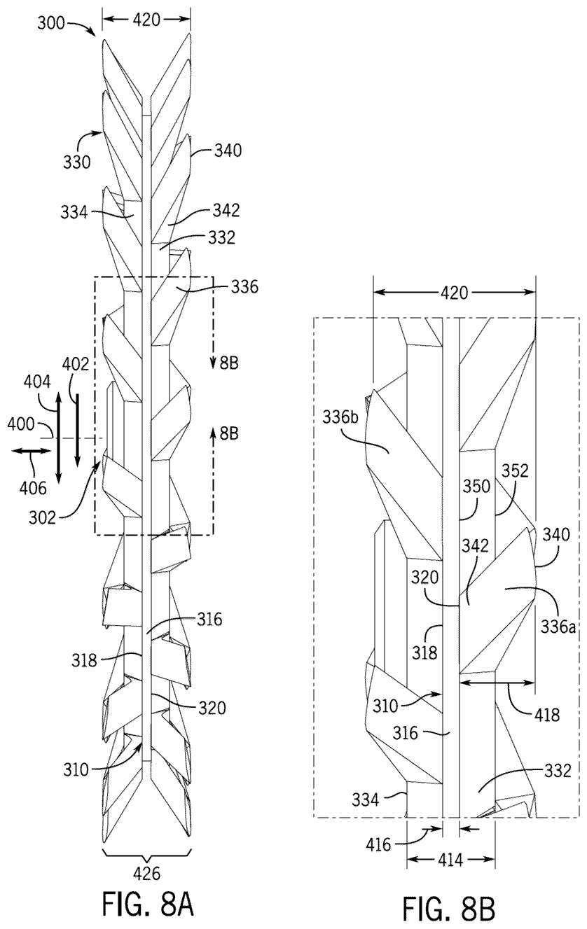

With reference to FIGS. 7A-8B, the closing wheel 300 may include one or more outward extending projections 336. The projections 336 may be continuous, such as blades or ridges, or discontinuous (e.g. segmented, discrete, or varying in dimension). In one example, the projections 336 are discretely defined and spaced features. The projections 336 may be teeth, tines, rods, or the like. The projections 336 may extend from a base 342 to a tip 340. The projections 336 may be generally elongated (e.g. extending outward a greater length than width or thickness).

The projections 336 may extend outward from the collar 330 or the rim 310. For example, the projections 336 may extend from the periphery 316 of the rim 310 or the exterior radial side 356 of the collar 330. The projections 336 may be integrally formed with at least one of the collar 330 or rim 310, or separately connected to the rim 310 or collar 330. For example, the base 342 may be formed with or attached to the rim 310 or collar 330.

The projections 336 may extend outward in the radial direction 404. For example, the projections 336 may have a radial height 412 from the base 342 to the tip 340. The projections 336 radially extend beyond at least the periphery 316 of the rim 310. For example, the projections 336 may terminate at the tip 340 positioned radially 404 outward from at least the periphery 316. Accordingly, the projections 336 may define the radial width or height 428 (e.g. diameter) of the closing wheel 300.

The projections 336 may extend at an angle 408 towards or against the direction of rotation 402, as exemplified in FIG. 7B. For example, the projections 336 may be oriented at an angle 408 and extend in a forward or rearward direction. In examples where the closing wheel 300 is circular or elliptical, the angle 408 may be a circumferential angle. The angle 408 may be defined relative to the periphery 316 of the rim 310, or relative to the radial exterior side 356 of the collar 330. In one example, a forward direction may be a direction 410 oriented at least partially towards the rotational direction 402. A rearward direction may be when the direction 410 is oriented at least partially against the rotational direction 402.

The projections 336 may at least partially extend outward axially 406. For example, the projections 336 may extend outward from the base 342 at least partially along the axis of rotation 400. The projections 336 may have an axial width 418 between the base 342 and the tip 340. In some examples, the projection 336 (e.g. the tip 340) may terminate axially outward from either or both the rim 310 or collar 330. In some examples, the projections 336 may be the most axially outward feature of the closing wheel 300 adjacent the periphery 316.

The projections 336 may be arranged about the wheel 300. The projections 336 may be annularly spaced around the axis of rotation 400. The projections 336 may be arranged in one or more annular rows or patterns. For example, as shown in FIG. 7B, a first projection 336a may be spaced annularly by a distance 422 from a second projection 336c, as may be shown in FIGS. 7B and 8B. The distance 422 between the projections 336 may be the same (e.g. repeat) or vary between each of the projections 336, or a row or series of projections 336.

In some examples, the wheel 300 may include two or more series of projections 336. In some examples, as may be shown in FIGS. 5A or 5B, a first series or row of projections 336a may be annularly or axially spaced from a second series or row of projections 336b. In examples where the wheel 300 includes a first collar 332 and a second collar 334, the first series or row of projections 336a may extend from the first collar 332 and the second series of projections 336b may extend from the second collar 334. In some examples, both the first row of projections 336a and the second row of projections 336b may extend from a same or a single collar 330.

With reference to FIG. 8B, the first series of projections 336a and the second series of projections 336b may be axially spaced such that at least the tips 340 are spaced by a projection axial distance 420. The axial projection spacing 420 may be defined in part by the axial spacing 416 of the at least two collars 332, 334. For example, the axial spacing of the collars 432, 434 may be a width of the rim 310 may define at least a portion of the axial spacing 420 of the collars 332, 334 or projections 336a, 336b. The rim 310 width or axial spacing of the collars 432, 434 may be between 0.25 and 2 inches. In one example, the rim 310 has a 0.25 inch width.

In some examples, at least one or both of the series of projections 336a, 336b extends axially 406, or has an axial width 418, to at least partially define the axial spacing 420. In some examples, the series of projections 336a, 336b are axially spaced both by the axial width 418 of the projections 336a, 336b, and the axial spacing 416 of the collars 332, 334. In some examples, the projection 336a, 336b axial spacing 420 defines the maximum or greatest width (e.g. the axial width) of the closing wheel 300. For example, the axial width 420 of the closing wheel 300 may be defined by the axial distance 420 between the first projection 336a tip 340 and the second projection 336b tip 340. In some examples, the axial width 420 may be between 1 and 3 inches, or greater depending on the application. In one example, the axial width 420 is approximately 2.5 inches.

With reference to FIGS. 5A-5B and 7B, the first series of projections 336a and the second series of projections 336b may be annularly aligned or offset across the rim 310. For example, as shown in FIGS. 5A and 7B, the projections 336a, 336b may be annularly offset by a distance 424. The distance 424 may be less than the distance 422, such that at least one second projection 336b is positioned between at least two first projections 336a, 336c. In other examples, as exemplified in FIG. 5B, the first projections 336a may be aligned annularly with the second series of projections 336b such that at least one second projection 336b is only axially spaced from a first projection 336a. For example, the first projections 336a and the second projections 336b may be positioned adjacent or paired relative to the rim 310. In such an example, relative the rim 310, or a major plane of the wheel 300, the projections 336a, 336b or the first collar 332 and second collar 334 may be mirrored of the other or symmetrical.

The two series of projections 336a, 336b may define a seed gap 426. The seed gap 426 is a volume of space between the projections 336a, 336b sufficient for a seed of a crop to pass between the projections 336a, 336b during use. For example, the projections 336a, 336b can engage with sidewalls 452 of an open furrow 450 without contacting or displacing a seed 458 from the furrow 450 as illustrated in FIG. 4A. For example, the seed gap 426 may be defined in part by the axial spacing 420 between the projections 336a, 336b, and the radial extension of the projections 336 relative to the periphery 316. The seed gap 426 may have a greatest width between the tips 340 of the projections 336a, 336b.

In some examples, the projections 336 may extend axially inward from the base 342. For example, each of the series of projections 336a, 336b may extend towards the other series. In such an example, the base 342 of the series of projections 336a, 336b may be axially spaced by a distance 416 sufficient distance to define a seed gap 426. In such an example, the inward orientation of the projections 336a, 336b may assist in preventing or reducing the occurrence of debris wrapping on the wheel 300. In some examples, the series of projections 336a, 336b may each be on the same side of a wheel and one of the series 336a, 336b may extend axially outward while the other extends axially inward relative to the periphery 316. In such an example, the opposing direction of the series of projections 336a, 336b may define the seed gap 426.

In some examples, the wheel 300 may be defined with a feature extending radially outward between the series 336a, 336b of the projections. For example, a portion of the periphery 316 may extend radially outward between the projections 336a, 336b, but interior of the tips 340. In other examples, the feature may be defined by a collar 330, or two or more collars 332, 334. The feature may have a sloping or rectilinear exterior, such as a triangular, spherical, or rectangular cross section. During use, the feature may assist in preventing the build of plant material between or on the projections 336a, 336b.

The components of the closing wheel 300 may be formed at least in part from metallic materials. For example, the collar 330, rim 310, or hub 302 of the closing wheel 300 may include steel, iron, aluminum, or the like. The components of the closing wheel 300 may be formed by cold or hot rolling, extruding, casting, or machining. In some examples, the closing wheel 300 may be coated or painted to reduce or prevent corrosion. The metallic materials may contribute to a heavy wheel 300, or heavier than conventional plastic or rubber wheels, thereby reducing upward deflection from contact with debris and increased force on the soil during use.

In examples where the rim 310 and the collar 330 are connected by welding, the rim 310 can be welded to the collar 330 by spot welding, or annularly spaced welds along the periphery 316 of the rim 310 and collar 330. Spot welding may be quicker for a manufacturer to assemble the wheel 300, or for a purchaser of the separate components to assembly the wheel 300. In some examples, the rim 310 and collar 330 may be connected continuous welding around all of or larger sections of the periphery 316 in comparison to spot welding. Continuous welds may be stronger or more durable, but may take a longer period of time to assemble or greater skill of a welder.

In some examples, a separate component may be attached to one or both of the rim 310 or collar 330 and used as a welding surface to assist in decreasing a time or difficulty to connect the components. For example, as may be shown in FIGS. 5A-6, the wheel 300 may include one or more connection portions 390. The connection portions may be U-shaped features defining a channel. The connection portions 390 may fit over, or connect to, the collar 330. For example, the collar 330 may fit within the channel, with the connection portion 390 placed between the projections 336. The connection portions 390 may be initially connected to the collar 330, such as by fasteners, welding, or press-fit, or the like. In some examples, the connection portions 390 may be positioned between the projection 336, which may limit relative movement of the collar 330 and the connection portions 390. The connection portions 390 may have an exterior side 391 and an opposing interior side 392. The interior side 392 may have a profile corresponding to one or both of the sides 318, 320 of the rim 310. The interior side 392 of the connection portion 390 may then be connected or welded to the rim 390. The connection portion 390 may provide the quickness of assembly of spot welding and improved strength similar to the continuous welding.

With reference to FIGS. 3-4B, the hub 302 and the rim 310 may be connected. For example, the hub 302 may be positioned within or connected to the rim 310 at the central aperture 312. The hub 302 may receive or connect with the extending feature 256 (e.g. arm, fork, axle) of the trailing arm assembly 100. In some examples, the arm 256 may connect to the secondary apertures 314 or directly to the central aperture 314. In such an example, the hub 302 can be redundant to a secondary hub feature connected at the secondary apertures 314. The secondary hub feature can be rotatable relative to the arm 256, or otherwise enable rotation of the wheel 300 about the axis of rotation 400. The arm 256 may connect to either or both sides (e.g. axial sides 318, 320) of the closing wheel 300. The assembled closing wheel 300 may have a height or width 428 between 8 and 20 inches, or commonly between 10 and 14 inches. In one example, the wheel diameter or width 428 is 13 inches.

During use the closing wheel 300 may be positioned on a field surface 430. The closing wheel 300 may be positioned in or pulled into an open seed furrow 450, as exemplified in FIGS. 4A and 4B. FIGS. 4A and 4B may show the rear or ascending portion 362 of the closing wheel 300. At operation, the closing wheel 300 rotates in the rotational direction 402 about the axis of rotation 400 when the tractor 50 is in motion. The axis of rotation 400 may be oriented substantially parallel to the surface of a field 430, such that the rotation is mostly orthogonal to the surface of the field 430.

With reference to the open seed furrow 450, the open seed furrow 450 may have sidewalls 452 extending to a bottom 454. The opening assembly 102 may open the furrow 450 by cutting or removing soil, such as by conventional or no-till methods, and deposit a seed 458 in the open furrow 450. The cutting action may cause the sidewalls 452 to be more compacted or hardened compared to the surrounding soil 430, which may limit movement of moisture into the furrow, or consistent compaction with filling soil to define a closed furrow 460 and the surrounding soil 430 absent the present closing wheel 300.

As the closing wheel 300 rotates, it may break up or move soil to fill the open furrow 450 (e.g. cover the seed 458) to define a closed furrow 460. For example, the closing wheel 300 may apply a downward force, a cutting action, or apply a pressure sufficient to move, break up, or engage soil of, around, or into an open seed furrow 450 and form a closed seed furrow 460. The force may originate in part with the trailing arm assembly 100 or the weight of the closing wheels 300. In some examples, a metallic closing wheel 300 may provide increased downward force or weight to assist in breaking down the soil. In some examples, a metallic closing wheel 300 may be resistant to bouncing or deflection and may maintain a more consistent downward force on the soil 430. Breaking down soil, or even debris in the soil (e.g. plant matter) and reducing air pockets in the soil 430 can improve the capillary action of the moisture in the soil 430, helping water reach the growing plant or promoting the development of symbiotic, or otherwise beneficial, organisms such as fungi or bacterium, as well as reducing wind erosion of the soil over the seed 458.

The axial spacing 420 and radial extension of the projections 336 assists in breaking down the soil while limiting or reducing contact with or displacement of the seed 458. For example, the axial spacing 420 between projections 336a, 336b may position the projections 336 in contact with the sidewalls 452 of the open furrow 450. With the projections 336 in contact with the sidewalls 452, the axial spacing 420 may position the projections 336 spaced from the seed 458, or the bottom of the furrow 450. The radial extension of the projections 336 may position the rim 310 or collar 330 spaced from the seed 458.

The axial extension of the projections 336 may assist in breaking down the sidewalls 452 or breaking up the soil 430. For example, as the axially extending projections 336 move through the soil, the axial extension may move the projections 336 through a larger cross sectional area of the soil 430, which may assist in penetrating thick sidewalls 452 or moving more soil 430 into the furrow 450. The axial extension of projections 336 may also increase a tolerance for avoiding contact with the seeds 458. For example, the axial extending projections 336 may have an increased volume between the projections 336, such as a seed gap 426, in comparison to a non-axial extending feature. During use the seed gap 426 may be sufficiently large to close or break down the open furrow 420 while passing over and avoiding displacement of the seed 458 form the furrow. Further, the axial and radial spacing of the extensions 336 relative to the rim 310, e.g. the seed gap 426, may accommodate variation or tolerances in the positions of the components of the trailing arm assembly 100, such as between the opener assembly 150 and the closing wheel 300, while avoiding contact with the seed 458.

The axial spacing and radial extension together may enable various depths of the closing wheel 300 into the soil 430 without disturbing the seed 458. For example, the tips 340 may remain spaced from the seed 458 even if the wheel 300 is positioned to engage a depth of soil 430 deeper or lower than the seed 458. The axial extension or width 418 of the projections 336 may position the projections 336 in a spaced relationship from the seed 458 at a variety of depths. In some examples, the axial spacing 420 may be adjusted by changing a width 416 of the rim 310. For example, the same first collar 332 and second collar 334 may be used with a thicker or thinner rim 310, to change the axial spacing 416 of the collars 332, 334, thereby reducing the number of unique parts required for unique assemblies. In some examples, the axial extension of the projections 336, or the axial width 418, may be increased or decreased to adjust the axial spacing 420. For example, a greater spacing 420 may be used for a wider furrow 450, more tolerance to avoid a seed 458, or engage a larger quantity of surrounding soil 430. A more narrow spacing 420 may provide greater shear force to break up soil or be used for a narrower furrow 450.

The discretely defined or segmented projections 336 may assist in releasing mud or debris from the projections 336. The offset alignment between the series of projections 336a, 336b may maintain engagement with the open furrow 450, such as at least one sidewall 452. For example, by staggering the projections 336a, 336b, at least one projection 336a, 336b may remain in contact with the open furrow 450. Maintaining a projection in the soil 430 may also resist bouncing, such as when encountering debris.

By using a closing wheel 300 including two axially spaced, but annularly arranged, projections 336, or similar soil engaging features, the closing wheel 300 may be positioned to rotate 402 orthogonal to the field 430. In comparison, some closing wheels 300 are paired and offset at an angle to engage with two sidewalls 452 of the furrow 450, which may result in uneven wear and a greater effective width of the assembly. In contrast, by rotating about an axis 400 generally parallel to the field 430, the closing wheel 300 has a narrower effective width and may be positioned with trailing assemblies 100 in a variety of spacings, either narrower or wider. As a result, the closing wheel 300 may be used for crop planting at increased densities, such as in comparison to wheels requiring an angled orientation, or in other arrangements increasing total yields or plant health.

The closing wheel 300 may be reversible or able to be used with the projections 336 positioned at a rearward or forward angle 408. For example, as shown in FIG. 7A, the projections 336 may extend in one direction relative to the soil 430 along a descending portion 360 and a different direction relative to the soil 430 along an ascending portion 362, where the ascending portion 362 and descending portion 360 are separated by the axis of rotation 400. The forward or rearward angle 408 of the projections 336 may assist in breaking down soil 430, uniform distribution of soil, or reducing air pockets.

A forward angle 408 projection 336, where the projection 336 extends in the direction of rotation 402 (e.g. downward along a descending portion 360 and upward relative to the field 430 along an ascending portion 362), may provide a more aggressive cutting action of the soil 430. For example, the projections 336 may be more vertically aligned at initial contact with the soil 430 or sidewalls 452, which may increase a concentration of forces to break down soil. However, forward orientation may result in the projections 336 carrying soil as they leave the closed furrow 460, risking reopening the furrow, or displacing a seed 458.

A rearward angle 408 projection 336, where the projection 336 extends at least partially away from the direction of rotation 402 (e.g. upward along a descending portion 360 and downward relative to the field 430 along an ascending portion 362), may reduce the risk of soil 430 displacement and promote consistent soil compaction. As a rearward projection 336 engages the furrow 450, such as at the sidewalls 452, the projections 336 may be oriented radially at least partially in the direction of the furrow 450, as may be shown by the front or descending portion of the closing wheel depicted in FIG. 8A. As a result, the elongation of the projections 336 may increase a total surface area of the projection 336 in contact with the sidewalls 452, thereby breaking down a larger volume of soil 430. Further, as the projections 336 exit the soil, they may be oriented more vertically, thereby exiting the soil with minimal surface area and oriented in the direction of removal (e.g. rotation 402). As such, the rearward angle 408 may reduce the displacement of any soil 430 and promote a larger volume of broken up soil. The removal of the projections 336 may also leave indentations or openings for moisture to funnel into the closed furrow 460 or towards the seeds 458 generally. The vertical removal of the projections 336 may also shed dirt, mud, or other debris to assist in planting in a variety of conditions.

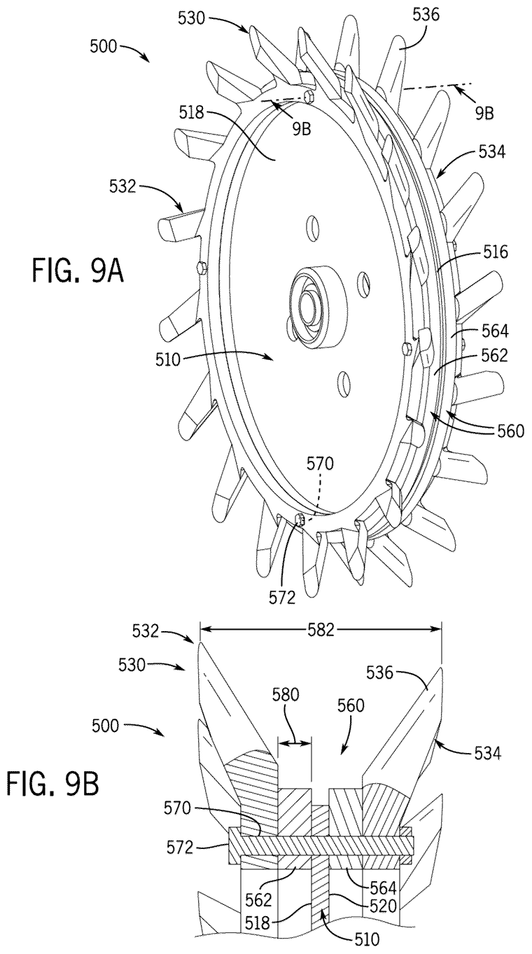

Turning to FIGS. 9A and 9B, another example of the closing wheel 500 is depicted. The closing wheel 500 may additionally include one or more spacers 560 to increase an axial width 582 of the projections 536. The closing wheel 500 may be similar to the closing wheel 300 and include a rim 510 and a collar 530 including one or more projections 536. The rim 510 defines a first side 518 and an opposing second side 520. The outer portion or perimeter of the rim 510 defines a periphery 516.

The collar 530 may be one or more rings or annular features and include a plurality of projections 536 extending outward. In some examples, the collar 530 may be an assembly defined by a first collar 532 and a second collar 534. The projections 536 of the first collar 532 and the second collar 534 may extend, at least in part, in opposing directions. For example, the projections 536 may each extend away from a midline of the wheel 500 (e.g. axially outward). The projections 536 may define the axial width of the wheel 500.

The closing wheel 500 may include one or more spacers 560 to increase the axial width of the wheel 500 or axial spacing 582 between the projections 536. The spacers 560 may be a ring, plate, or other feature having a thickness 580. In one example, the spacers 560 are a featureless ring. The spacers 560 may be continuous or segmented. In some examples, the spacer 560 may include a first spacer 562 and a second spacer 564 to be positioned on either side of the rim 510.

The closing wheel 500 may be assembled with at least one spacer 560 positioned, at least in part, between the rim 510 and the collar 530. The first spacer 562 may be positioned between the first side 518 of the rim 510 and the first collar 532. The second spacer 564 may be positioned between the second side 520 of the rim 510 and the second collar 534. The spacers 560 may cover the sides 518, 520 or extend annularly about the sides 518, 520 of the rim 510. In examples where the spacer 560 is continuous, the spacer 560 may extend along or adjacent the periphery 516. In other examples, the spacer 560 may be discontinuous or segmented and defined by a plurality of separate features. In such an example, the separate features defining the spacers 560 may be annularly spaced along and positioned between the rim 510 and the collar 530.

The spacer 560, collar 530, and rim 510 may be fixedly connected or selectively connected. For example, the spacer 560, collar 530, and rim 510 may be fixedly connected by one or more welds or adhesives. The spacer 560, collar 530, and rim 510 may be selectively connected by one or more fasteners 572. For example, the spacer 560, collar 530, and rim 510 may defined one or more corresponding apertures 570. When the apertures 570 are aligned, a fastener 572 such as a bolt, screw, or rivet, may be positioned within the apertures 570 to securely connect the spacer 560, collar 530, and rim 510 together. The fasteners 572 and apertures 570 may be spaced about the periphery 516. In examples including a fastener 572, the collar 530 or spacers 560 may have a sufficient radial thickness to define the apertures 570 and securely receive and retain the fastener 572. In some examples, the fasteners 572 may be used for wheels 500 without a spacer 560.

The spacers 560 increase the axial width 582 of the closing wheel 500 or collars 530. By increasing the axial width 582, the projections 536 may be further spaced to either or both break down a wide open seed furrow and move a larger volume of dirt surrounding the seed furrow to assist in covering a planted seed. In some examples, selective connection of the spacer 560, collar 530, and rim 510, such as by the fasteners 572, may enable adjustment of the axial width 582, such as by selectively adding or removing spacers 560, to match the needs of various soil conditions, planted crops, seed furrow widths, or the like.

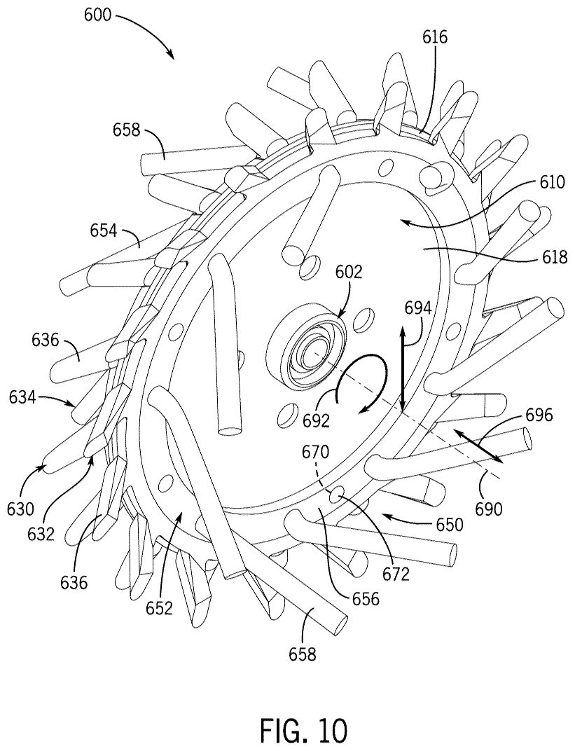

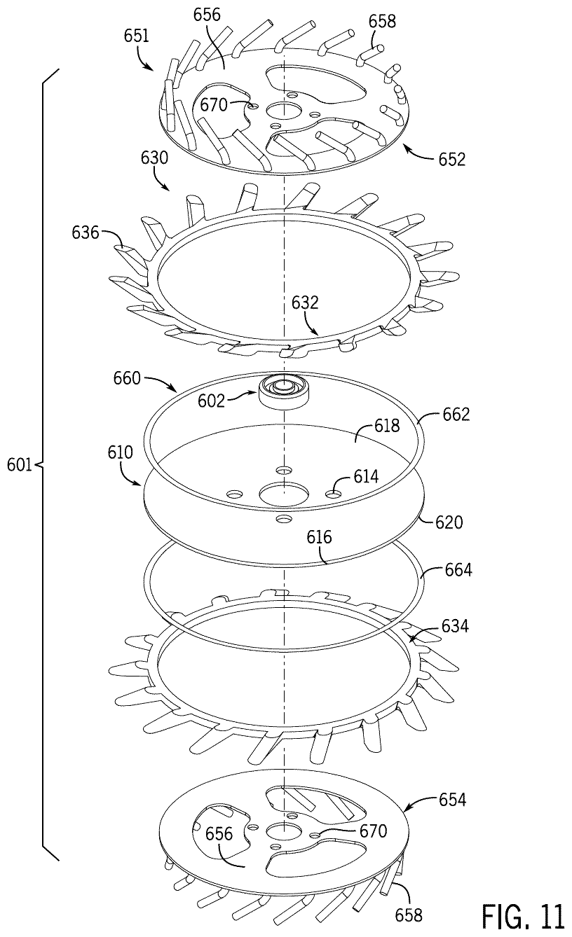

Turning to FIGS. 10 and 11 additional example closing wheels 600 are depicted. The closing wheels 600 may be similar to the closing wheel 300 or 500 and include a rim 610 and a collar 630 including one or more radially extending projections 636. The rim 610 defines a first side 618 and an opposing second side (not shown). The outer portion or perimeter of the rim 610 defines a periphery 616.

The closing wheel 600 in this embodiment may include supplemental tread wheels 650, also referred to herein as an angle-collars, each defining protrusion features. For example, FIG. 10 shows a first supplemental angle-collar 650 and FIG. 11 shows another example supplemental angle-collar 651. The supplemental angle-collar 650 includes a plurality of protrusions 658. The plurality of protrusions 658 may be tines, rods, beams, or the like positioned annularly spaced on a base 656. Each protrusion may be bent to extend at angle relative to the base 656, such as in manner swept-away from the direction of rotation. For instance, in FIG. 10, the protrusions are angled in a counter clockwise direction compared to the rotation of the closing wheel in a clockwise rotation.

In some examples, two or more angle-collars 652, 654 may be positioned on opposing sides of the wheel 600. For example, a first angle-collar 652 may be positioned against the first side 618 of the rim 610 and the second angle-collar 654 on an opposing side of the rim 610. The first angle-collar 652 may be positioned on the same side as the first collar 632 and the second angle-collar 654 may be positioned on the same side as the second collar 634. In some examples, the base 656 is coupled to one or both sides of the rim 610. The base 656 may include a continuous annular rim, or may be a planar circular plate, or may include one or more spokes, or the like.

The protrusions 658 may be spaced such that a plurality of voids or gaps are defined between the protrusions 658. The protrusions may extend outward, such as a first portion extending at least partially in the axial direction 696, from one or both sides 618 of the closing wheel 600. The protrusions 658 may additionally extend against the direction of rotation 692. For example, a second portion of the protrusion 658 may be swept back (in a direction opposite that of rotation), and in one example may be oriented at an angle relative to the first portion, the angle being between 0 degrees and 90 degrees. The protrusions 658 may extend from or be formed integrally with the tread rim 656. In other examples, the protrusions 658 may extend from the rim 610. In some examples, the protrusions 658 may extend at least partially into or through the wheel 600, such as through the collar 630 and/or the rim 610.

The tread wheels 650 may be connected to the wheel 600 such that the protrusions 658 are positioned radially inward from the projections 636. With reference to FIG. 10, the tread rim 656 may be a ring or annular feature. The ring cap 656 may have an outer diameter less than the inner diameter of the collar 630. The tread rim 656 may define one or more apertures 670 to align with corresponding apertures of the rim 610 or collar 630, such as at or adjacent the periphery 616. One or more fasteners 672 may be received in the apertures 670 to connect the tread rim 656, and tread wheel 650, to the wheel 600. In some examples, the tread rim 656 may be additionally or alternatively connected by welding, brackets, adhesives, or the like.

FIG. 11 shows another example of the tread wheel 651. The example of FIG. 11 includes tread rim 656 in the form of a disc or spoked wheel. In such an example, the tread cap 656 may similarly define apertures 670, such as at or adjacent the hub 602, to selectively connect the tread wheel 651 to the wheel 600 with a fastener. Alternatively, it may be welded together.

As shown in FIG. 11, a wheel 600 including tread wheels 650, 651 may optionally include one or more spacers 660. For example, a spacer 660 may be positioned between the tread wheel 650, 651 and the collar 630 or rim 610, or between the collar 630 and rim 610. In some examples, a first spacer 662 may be positioned on the first side 618, and a second spacer 664 positioned opposite the first spacer 662 on second side 620. The spacers 662, 664 may be discs, plates, or rings having a thickness. The spacers allow the

As described herein, the closing wheel 600 including a tread wheel 650 may be described as a closing wheel and press wheel combination. For example, the closing wheel assembly 600 may condition soil over and around the area affected by the closed furrow 460 in addition to at least partially closing the seed furrow 460.

For example, during use, with reference to FIG. 4B, the seed 458 is positioned at the bottom of the furrow 460. However, even after breaking down the furrow sidewalls 452, the surrounding field surface 430 may hardened or include cracks and seams, such as from too much or too little moisture. Specifically, the walls 452 of the furrow come together by the action of the extensions 636 during the closing process, but the soil is not necessarily interlaced between the outward from the walls 452.

In accordance with various embodiments, the closing wheel 600 may be approximately centered on furrow with the extensions penetrating into the sidewalls 452 and the soil, while the tread wheel 650 is positioned along the top, or slightly into the top, of the field surface 430. The tread wheel 650 applies a downward pressure over the field surface 430. In such an example, wheel 600 and the tread wheels 650 may imprint a tread pattern on the ground. The tread pattern may resemble a chicken track. The presence of voids between the adjacent treads 658 allow for condition of the ground allowing some soil to pass through the voids and only making contact with the projections 636 and/or the protrusions 658. The projections 636 and protrusions 658 each turn the soil to compact and unify the soil around the seed 458. As a result, the capillary action of the soil may be enhanced to promote moisture around the seed 458 and through a larger volume of soil. Further, the interlaced soil may assist in promoting root development of the planted crop.

The closing wheel 600 discussed herein may not smear the soil over the furrow. Instead, the closing wheel 600 may engage and press the soil into the voids between the protrusions 658 thus preventing or limiting the closing wheel from forcing and/or smearing the soil. Further, the tread protrusions 658 may limit or prevent soil from smearing or adhering to the sides of the wheel 600. By not forcing soil out from under the closing wheel 700 by the tread wheels 650, 651, but instead merely moving soil into the voids between the protrusions 658 and over the closed furrow seam, it leaves a mellow treated soil that limits or prevents the soil from crusting over the seeded furrow 460.

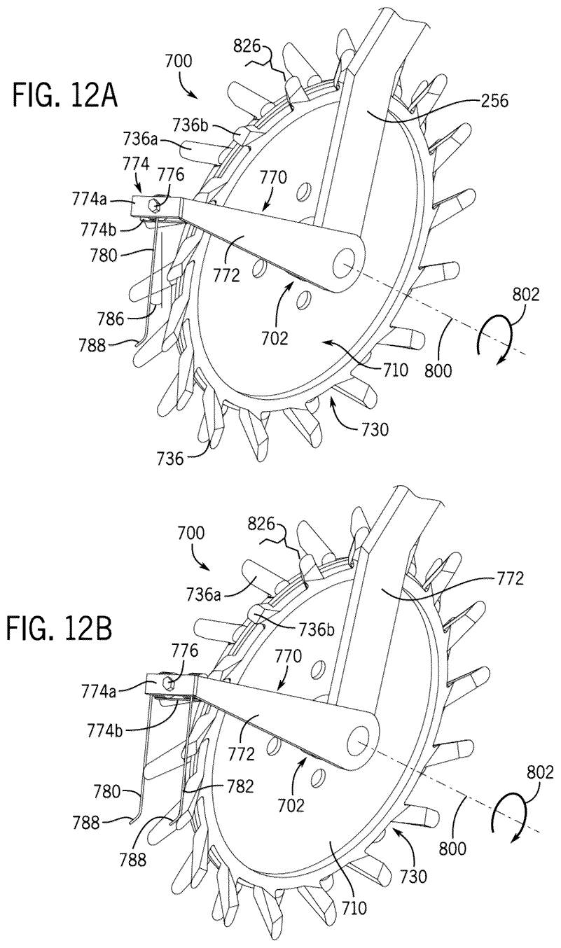

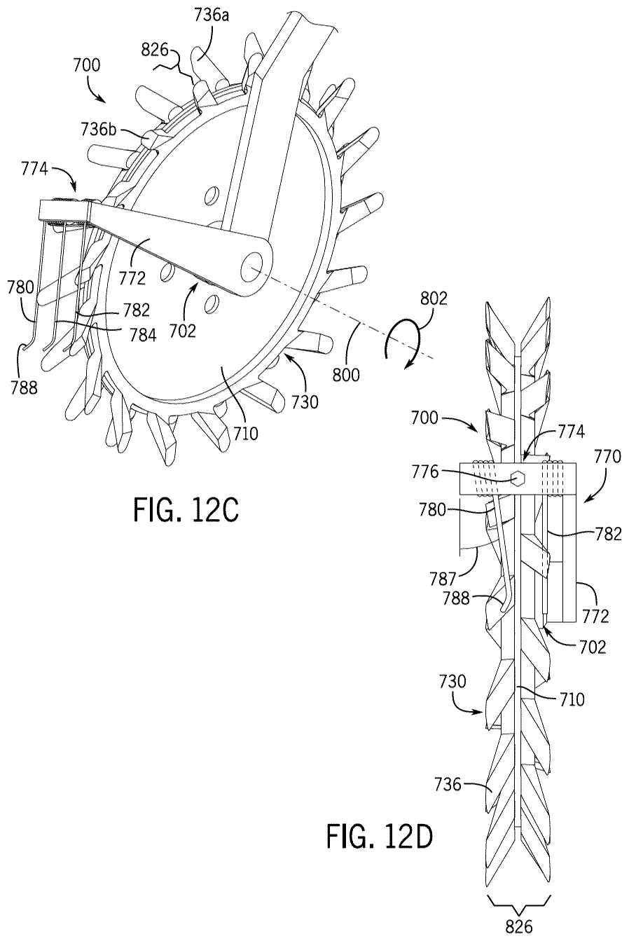

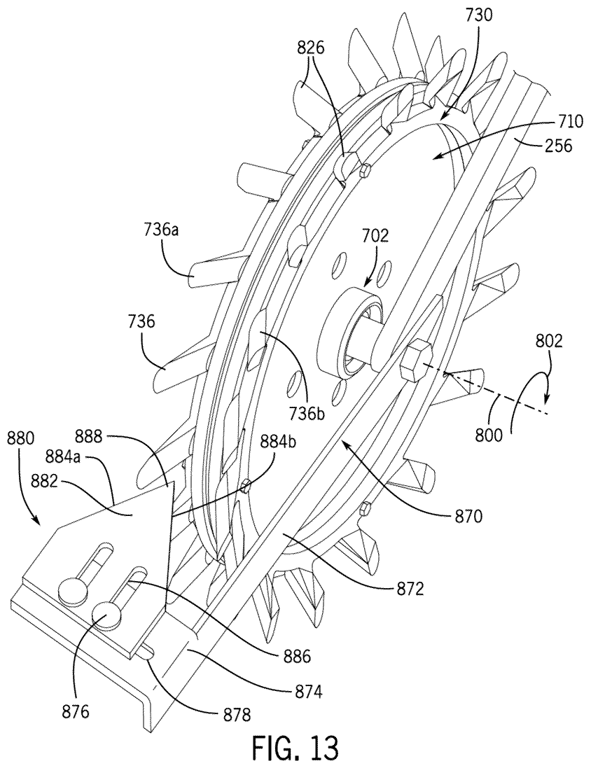

Turning to FIGS. 12A-12D and FIG. 13, various examples of debris removing or scraper assemblies for use with the closing wheel examples are depicted.

The closing wheel 700 of FIGS. 12A-12D may be similar to or the same as the closing wheels described herein, such as in FIG. 5A. For example, the closing wheel 700 may include a hub 702, a rim 710 and a collar 730. The collar 730, or the wheel 700, may define a plurality of radial projections 736. A first series 736a of the extensions may be axially spaced (e.g. spaced along the axis of rotation 800) from a second series of projections 736b to define a seed gap 826. The wheel 700 may be connected to a trailing arm assembly 100 by a link or extension 256, which may be connected at the hub 702.

The closing wheel assemblies 700 may include a scraper assembly 770, illustrated in FIGS. 12A-12D. The scraper assemblies 770 may be selectively connected to or selectively positioned relative to the closing wheel 700 to remove or limit the build up of debris such as plant matter or mud on or near the outer edge of the wheel, such as the radial projections 736.

The scraper assemblies 770 may include an arm or radial extension 772. The arm 772 may be selectively attached to the link 256 or to the wheel 700, such as at the hub 702. The arm 772 may extend from the hub 702, or other position, to a position radially outward and adjacent to the projections 736. The arm 772 may remain in a fixed position or orientation during rotation of the wheel 700. The scraper assemblies 770 may include a bracket or mount 774 extending from or attached to an end of the arm 772 opposite the hub 702. In one example, the bracket 774 includes a first 774a and second 774b portion selectively connected by an adjustable feature 776. In one example, the adjustable feature 776 may be a threaded feature (e.g. a screw or bolt) which changes a vertical position by rotation.

The scraper assembly 770 includes one or more scraper features. For example, FIG. 12A depicts a first scraper feature 780. The scraper feature 780 may be a rigid or resiliently deflectable structure including an elongated portion and optionally having a tip portion 788 that bends away from the wheel. In one example, the tip portion bends at an approximately 30 degree angle, and is about one inch in length. For example, the scraper feature 780 may be a pick, blade, spring wire or similar components. In one example, the scraper feature 780 is a coiled cable defining a spring at one end and an extending tine on an opposing end. In such an example, the coiled cable is connected to the bracket 774 with the tine extending outward. The adjustable feature 776 may manipulate the positions of the portions 774a, 774b to adjustably position the scraper feature 780, such as the tine, in various orientations relative to the wheel 700, such as between or over the projections 736.

With reference to the example depicted in FIG. 12A, the example scraper assembly 770 includes a single scraper feature 780 (shown with bent tip 788 as an example). The scraper feature 780 may be positioned near the projections, such as between the projections 736, such as in the seed gap 826, or on the outside of the projections 736. The scraper feature 780 may extend from the bracket 774 at an outward angle 786 (see FIG. 12A) In one example, the outward angle 786 is approximately 10-45 degrees. The outward angle 786 (FIG. 12A) may assist in positioning the scraper feature 780 to resiliently deflect when it contacts the projections 736 or rim 710.

During use, the scraper feature 780 may contact the projections 736 and deflect, and remove debris, such as plant matter, mud, or the like, from the seed gap 826 or extending between the projections 736. In examples where the scraper 780 is a coiled cable, the coil or spring portion may enable resiliently deflection of the scraper feature 780 to remove debris while also deflecting outwardly when contacting the projections 736 to prevent binding during rotation 802 of the wheel 800.

FIG. 12B depicts an example scraper assembly 770 including a first scraper feature 780 and a second scraper feature 782. The scraper features 780, 782 (each having the optional bent tip 788) may be axially spaced and positioned in line with or at least partially over the series of projections 736. The scraper features 780, 782 may be in contact with one or more of the projections 736, or positioned at a radially outward angle to extend above and adjacent to the projections 736. During use, the scraper features 780, 782 depicted in FIG. 12B may remove or deflect debris that sticks to or otherwise remains in contact with the projections 736 after exiting soil.

FIG. 12C depicts an example scraper assembly 770 including a first scraper feature 780 and a second scraper feature 782, and an additional third scraper 784, each having the optional bent tip 788). The first scraper feature 780 and second scraper 782 may be similarly positioned as in the example depicted in FIG. 12B. The third scraper feature 790 may be positioned in the seed gap 826, or between the projections 736, similar to the example depicted in FIG. 12A. As a result, the scraper assembly 770 of FIG. 12C may both remove or deflect debris that sticks to or otherwise remains in contact with the projections 736, extends between the projections 736, or is positioned within the seed gap 826.

FIG. 12D depicts a rear view of an example scraper assembly 770 which may be similar to the example assembly 770 depicted in FIG. 12B. The arm 256 is not shown in FIG. 12D. FIG. 12D depicts the adjustable positions of the scraper features 780, 782 by the bracket 774. In this example the bent tip 788 (on feature 780 only) is shown bent in a direction away from a plane of the wheel 700, or in other words in an axial direction. The feature 782 is straight in the illustrated example, to show that the more than one scraper features may be positioned differently from one another if desired. For example, the bracket 774 may be adjusted, such as by selectively loosening and tightening or releasing and securing the adjustable feature 776, to change an orientation of a scraper feature 780. For example, the scraper feature 780 may be adjustably positioned to extend an axially offset angle 787. The offset angle 787 may position the scraper feature 780 to extend towards (e.g. into) as shown in FIG. 12D, or away from the seed gap 826. In other examples, the scraper feature 780 may be adjustably positioned to extend from adjacent the seed gap 826 towards the projections 736. The scraper feature 780 may be similarly adjusted to change the magnitude of angle 786, shown in FIG. 12A. By adjustably positioning the scraper feature 780, the scraper assembly 770 may be adjusted to a position best suited for removing debris from a specific region of the wheel 700, or various types of debris found at a planting location. For example, weeds or thinner debris may more commonly build up on the projections 736, while mud or rocks may more commonly build up between the projections 736.

FIG. 13 illustrates another example of a scraper assembly 870. The scraper assembly 870 is described and illustrated with reference to the closing wheel 700. The scraper assembly 870 can include or be used in combination with at least some of the features of the scraper assemblies described herein with reference to FIGS. 12A-12D. In one example features that may be common include the arm 772 and the mount 774. Further, features of the scraper assembly 870 can replace or be used in combination with the examples of the scraper assemblies previously described.

The scraper assembly 870 includes a scraper 880 that can be positioned in contact with or adjacent a closing wheel 700 to remove debris (e.g. plant matter, soil, trash, or the like) from the closing wheel 700 during use. For example, the scraper 880 may remove debris from the sides or perimeter of one or more of the rim 710, collar 730, or the projections 736. The scraper assembly 870 of the present example includes an adjustably positionable scraper 880. The scraper 880 can be selectively positioned relative to the wheel 700 to remove debris from a desired location of the wheel 700, to increase or decrease the amount of debris removed by the scraper 880, or to accommodate various sizes of the wheel 700.

The scraper assembly 870 includes a positioning arm 872. The positioning arm 872 is connected to one or both of the link 256 to the trailing arm assembly or the wheel 700, such as at the hub 702. The positioning arm 872 extends from the connection location to an end positioned radially outward from or adjacent the perimeter of the wheel 700 (e.g. the edge of the rim 710, tips of the projections 736, or the like). For example, the arm 872 may have a length greater than a radius of the wheel 700.

The arm 872 defines or includes a platform or bracket 874 to selectively connect with the scraper 880. The bracket 874 is a mounting feature 874 for connection with the scraper 880. The bracket 874 is positioned adjacent or spaced outwardly from the perimeter of the wheel 700, such as at the end of the arm 872 opposite the connection location. The bracket 874 may extend outward from the arm 872 in a direction along the axis of rotation 800, and in some examples parallel to the axis of rotation 800. In some examples the bracket 874 may extend at an angle from the arm 872 in the direction of the wheel 700. For example, the bracket may extend at a 90 degree angle, or may extend at less than a 90 degree angle, or may extend at greater than a 90 degree angle from the arm 872 depending on the intended positioning of the scraper 880. In such an example, the bracket 874 may have a width dimension up to less than, equal to, or greater than the wheel 700 (e.g. width dimension 420 with reference to FIGS. 8A-8B).

The bracket 874 includes one or more openings 878 for connecting the scraper 880 to the bracket 874. For example, the bracket 874 can define an aperture 878 to receive a fastener 876 to selectively connect the scraper 880 and bracket 874. The openings 878 may be elongated and extend along at least a portion of the width dimension of the bracket 874. In another example, a plurality of openings are spaced apart along the width dimension of the bracket 874. Elongated openings or a plurality of spaced openings 878 define a plurality of positions to connect the scraper 880 to the bracket 874, and in turn a variety of positions for the scraper 880 relative to the wheel 700.

The scraper 880 has a main body 882. For example, the scraper 880 can be a plate, blade, pick, or the like. The scraper 880 can be rigid, semi-rigid or resiliently flexible, or flexible. In one example, the main body 882 is a metallic plate to improve durability and to assist in breaking up or off debris from the wheel 700. The main body 882 defines side edges 884a, 884b. The side edges 884a, 884b extend to a tip portion or contact portion 888. In one example, the side edges 884a, 884b converge to a point at the tip portion 888 to form a triangular shape. The tip portion 888 may be a sharp point a rounded point or a truncated shape that may be positioned relatively radially inwardly to fit between the rows of projections 736 (e.g., teeth) on the wheel 700, or may be positioned relatively radially outwardly from the projections 736. The tip portion 888 and the side edges 884a, 884b may combine to form a blade, and may define one or more edge features for removing debris.

The scraper 880 defines one or more openings 886 extending through the main body 882. The openings 886 can be elongated or spaced apart along a length of the scraper 880. For example, the openings 886 may extend towards or away from the tip portion 888. In one example, the main body 882 defines at least two openings 886 spaced along the width of the scraper 880 and extending along the length of the scraper 880. The openings 888 receive the fasteners 876 to couple the scraper 880 to the arm 872, or the bracket 874. The scraper 880 may be mounted to the bracket 874 in various positions by being adjusted radially inwardly or radially outwardly away from the hub 702 and the wheel 700 by being secured at various positions of the elongated openings 886.

At assembly, the scraper 880 is connected to the bracket 874. The fastener(s) 876 are positioned in each of the scraper openings 886 and the bracket openings 878. The connection is an adjustable connection such that the scraper 880 is movable relative to the bracket 874. The scraper openings 886 and the bracket openings 878 are elongated or spaced apart along two different dimensions. In one example, the bracket openings 878 are oriented along the axis of rotation 800 (e.g. a width dimension) and the scraper openings 886 are elongated along the length of the scraper 880 or along a radius from the axis of rotation (e.g. a length dimension). The position of the scraper 880 is selectively defined at a desired location along the width dimension and/or the length dimension relative to the wheel 700.

The scraper 880 extends from or is oriented relative to the bracket 874 such that the tip portion 888 is positioned at or adjacent the perimeter of the wheel 700. During use the tip portion 888, or the scraper 880 generally, contacts and removes debris from the wheel 700 as the wheel 700 rotates 802 about the axis of rotation 800.

The scraper 880 can be adjustably repositioned relative to the bracket 874 or wheel 700 to contact desired portions of the wheel 700. For example, the scraper 880 can be selectively positioned along the width of wheel 700 by adjusting the position of the scraper 880 along the width of the bracket 874 (e.g. the width dimension). In one example, the fastener 876 is selectively moved within, or selectively positioned in, the bracket openings 878 to position the scraper 880 at a desired position along the width of the bracket 874. As a result, the scraper 880, or tip portion 888, can be positioned over either of the first 736a or second projections 736b, or between the projections 736 and over or within the seed gap 826.

The proximity of the scraper 880 to the wheel 700 (e.g. the radial spacing) can also be adjusted. For example, the scraper 880 can be selectively positioned in contact with or spaced from the wheel 700. In one example, the fastener(s) 876 is selectively moved within, or selectively positioned within the scraper openings 886 to move the scraper 880, or tip portion 888, inward or outward relative to the axis of rotation 800 (e.g. the length dimension). By adjusting the radial spacing, the scraper 880 can be positioned within the seed gap 826 (e.g. between the projections 736), at a tip of the projections 736, or spaced outwardly from the projections 826.

The position of the scraper 880 can be fixed by a compressive engagement of the fastener 876 or a keyed engagement between one or more of the fasteners 876, bracket openings 878, or scraper openings 886. For example, the fastener 876 or rim of the openings 878, 886 can be faceted, indented, or define protrusions to limit relative movement.

The various positions of the scraper 880, or scraper assembly 870 generally, enable a user to customize the position of the scraper 880 to remove the debris commonly found in their fields or commonly associated with their planting conditions. The adjustable scraper 880 can also enable a single scraper assembly 870 to accommodate various different types of closing wheels, such as those with a greater or smaller diameter, or greater or smaller width or spacing between projections.

By preventing the build up of or by removing debris from the closing wheel 700 or projections 736, the closing wheel 700 may be operated with improved consistency over a variety of planting conditions. For example, debris free or cleared projections 736 may maintain a consistent level of contact and soil penetration along a seed furrow. The consistent contact and soil penetration assist in consistent pressure, penetration depths, and break down of the seed furrows and thus planting conditions for seeds deposited along the length of the furrow. Further, debris, which is commonly soil or plant matter, can be removed and deposited lightly or consistently such that the removed debris does not build up and choke or otherwise damage planted crops or seed furrows.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A closing wheel coupled to a trailing arm assembly of a planter, the closing wheel comprising:
a hub;
a rim coupled to the hub and including a periphery;
a first plurality of projections extending radially beyond the periphery; and
a second plurality of projections extending radially beyond the periphery;
wherein:
the first plurality of projections and the second plurality of projections extend at least partially axially outward relative to the hub; and
the first plurality of projections and the second plurality of projections extend at least partially in different directions.

2. The closing wheel of claim 1, wherein
the first plurality of projections are axially spaced from the second plurality of projections.

3. The closing wheel of claim 1, wherein the first plurality of projections and the second plurality of projections extend at least in one direction that is at a non-orthogonal angle relative to a major plane of the hub, the major plane of the hub being orthogonal to an axis of rotation.

4. The closing wheel of claim 1, wherein at least one of the first plurality of projections or the second plurality of projections are spaced annularly about the rim.

5. The closing wheel of claim 1, wherein the first plurality of projections and the second plurality of projections are symmetrical about a major plane defined by the rim.

6. The closing wheel of claim 1, wherein:
the rim comprises a collar defining the first plurality of projections or the second plurality of projections, and
the collar is separate from and coupled to the rim at or adjacent the periphery.

7. The closing wheel of claim 6, wherein:
the collar is a first collar coupled to a first side of the rim and defining the first plurality of projections; and
the closing wheel further comprises a second collar defining the second plurality of projections, the second collar coupled to a second side of the rim opposite the first side.

8. The closing wheel of claim 7, wherein
an axial thickness of the rim defines at least a portion of an axial spacing between the first plurality of projections and the second plurality of projections,
a seed gap volume is defined in part by the rim, the first plurality of projections and the second plurality of projections.

9. The closing wheel of claim 1, wherein the first plurality of projections and the second plurality of projections are integrally formed with the rim.

10. An agricultural wheel configured to rotate about an axis of rotation, comprising:
a rim defining a periphery;
first projections extending axially outward from the periphery in a first direction;
second projections extending axially outward from the periphery in a second direction different from the first direction; and
wherein:
the first projections are circumferentially spaced about the rim, and
the second projections are circumferentially spaced about the rim.

11. The agricultural wheel of claim 10, wherein:
the first projections and the second projections extend radially beyond the periphery of the rim.

12. The agricultural wheel of claim 10, further comprising:
a first collar defining the first projections and coupled to the rim;
a second collar defining the second projection and coupled to the rim; and
wherein the first collar and the second collar are separately formed from and connected to the rim.

13. The agricultural wheel of claim 10, wherein:
the rim rotates in a first direction about the axis of rotation to define an ascending region moving upward and a descending region moving downward relative to the axis of rotation and a field surface,
wherein:
the first projections or the second projections extend at least partially downward from the periphery at the ascending region towards the field surface, and
the first projections or the second projections extend at least partially upward from the periphery at the descending region in a direction away from the field surface.

14. The agricultural wheel of claim 10, wherein:
the rim defines a major plane orthogonal to the axis of rotation; and
the first projections and the second projections rotate substantially in plane parallel to the major plane.

15. A wheel for an agricultural assembly configured to rotate about an axis of rotation, comprising:
a rim including a periphery;
first projections extending radially outward from a first side of the rim; and
second projections extending radially outward from a second side of the rim opposite the first side;
wherein
the first projections and the second projections are spaced apart along the axis of rotation, and
a seed gap volume is defined between the projections to permit the passage of a seed between the first projections and the second projections when the first projections and the second projections are engaged with a furrow during use.

16. The wheel of claim 15, further comprising:
a scraper assembly including a scraper feature positioned at or adjacent the periphery, the first projections, or the second projections.

17. The wheel of claim 16, wherein an angular position of the scraper feature relative to the closing wheel is adjustable.

18. The wheel of claim 16, wherein the scraper assembly comprises:
a linkage extending from a connection at or adjacent the axis of rotation to the position,
a mounting feature spaced from the periphery, and
the scraper feature for removing debris from the wheel is coupled to the mounting feature at an adjustable connection.

19. The wheel of claim 16, wherein the scraper feature is movable by an adjustable connection to a position radially towards or away from the periphery, the first projections, or the second projections.

20. The wheel of claim 16, wherein the scraper feature is movable by an adjustable connection in a direction along the axis of rotation and along a width dimension of the wheel.
